(19) United States
(12) Patent Application Publication
(10) Pub. No.: US 2021/0284532 A1
(43) Pub. Date: Sep. 16, 2021

(54) METHOD FOR PRODUCING HYDROGEN FLUORIDE FROM HEXAFLUOROSILICIC ACID

(71) Applicant: New Chemical Products LLC, St. Petersburg (RU)

(72) Inventor: Dmitrii Stanislavovich PASHKEVICH, (US)

(21) Appl. No.: 16/332,689

(22) PCT Filed: Jun. 21, 2018
(86) PCT No.: PCT/RU2018/000411

§ 371 Date: Mar. 12, 2019

(51) Int. Cl. C01B 7/19

(52) U.S. Cl. CPC C01B 7/193; C01B 2210/0062; C01B 7/195

(57) ABSTRACT

This patent relates to the mineral waste treatment of the phosphate chemical industry, namely, treatments of hexafluorosilicic acid solutions formed specifically during the process of producing phosphoric acid with hydrogen fluoride. The method for obtaining hydrogen fluoride from hexafluorosilicic acid includes neutralizing the HSA solution with an alkaline agent, yielding a solid salt from the suspension, processing the salt in a fire of a hydrogen-containing fuel and an oxygen-containing oxidant, cooling the combustion products, eliminating the silicon dioxide from these products, condensing the hydrogen fluoride and water, and subsequently extracting the hydrogen fluoride.

### CROSS-REFERENCE

This patent application is a section 371 nationalization of PCT Application No. PCT/RU2018/000411 filed Jun. 21, 2018, which claims priority to Russian Patent Application No. RU2018107639 filed Mar. 1, 2018, which applications are each incorporated herein by specific reference in their entirety.

### BACKGROUND

### Field

This patent relates to the treatment of mineral waste of the phosphate chemical industry, namely, treatments of hexafluorosilicic acid (HSA) solutions, in particular those formed during the process of producing phosphoric acid with hydrogen fluoride (HF).

### Description of Related Art

HF is used as a feedstock in the production of uranium fluorides, coolants, electronic gases, and synthetic oils. It also serves as a catalyst in organic synthesis and other reactions.

HSA forms during the process of obtaining phosphoric acid and is extracted from the process cycle in the form of a 5-45% aqueous solution.

There is a known method for obtaining HF from HSA [U.S. Pat. No. 3,128,152, IPC S01V7/19, S0V7/193, publ. Apr. 7, 1964] based on the principle of neutralizing HSA with an aqueous solution of ammonia, which forms ammonium fluoride, following the equation (1):

H₂SiF₆+6NH₄OH=6NH₄F+4H₂O+SiO₂. (1)

Solid silicon dioxide is extracted through filtration and washed repeatedly to remove ammonium fluoride from the surface of the crystals. Then the dilute ammonium fluoride solution is subjected to evaporation, forming ammonium bifluoride following the equation:

6NH₄F=3NH₄HF₂+3NH₃. (2)

The resulting ammonia is sent to the HSA neutralization stage. The resulting ammonium bifluoride is oxidized with oxygen or an oxygen-containing agent, according to the equation:

4NH₄HF₂+3O₂=2N₂+8HF+6H₂O. (3)

The obtained HF is extracted via absorption using water.

The disadvantages of this method are, firstly, the presence of a difficult-to-filter SiO₂ suspension due to the multiple washes, which introduce a large amount of water into the production cycle, leading to an increase in the energy intensity during the subsequent evaporation. Secondly, the ammonia yielded in the form of water condensate, with a concentration of about 5 wt %, must be pre-treated in an energy-intensive strengthening stage.

The known method [U.S. Pat. No. 4,062,930, IPC S01V 7/22, publ. Dec. 13, 1977; Dahlke T., Ruffiner O., Cant R., Production of HF from H₂SiF₆, Procedia Engineering, 138, 231-239 (2016)] of processing HSA to obtain HF is based on decomposing HSA using concentrated sulfuric acid, which forms silicon tetrafluoride and fluorosulfuric acid:

(nH₂O+H₂SiF₆)_{liq}+H₂SO_{4 lic}=(HSO₃F+mH₂O)_{liq}+SiF_{4 gas}. (4)

An aqueous solution of fluorosulfuric acid is heated to a temperature of 150-170 ° C., at which the acid is decomposed to form sulfuric acid and HF:

(HSO₃F+mH₂O)_{liq}→(mH₂O+H₂SO₄)_{liq}+HF_{gas} (5)

The silicon tetrafluoride, forming during the decomposition stage of HSA in sulfuric acid, is recycled and mixed with the initial HSA solution, resulting in the reaction:

3SiF₄+2H₂O=2H₂SiF₆+SiO₂. (6)

The strengthened solution of HSA is sent for decomposition in sulfuric acid, while the silicon dioxide is filtered and diverted for further use.

The main drawback to this method lies in the fact that 75% sulfuric acid contaminated with HF forms as a byproduct in an amount of about 30 kg per 1 kg of obtained HF. Recycling these waste streams typically involves neutralization with an alkali and disposal of the resulting solid salts, which leads not only to a loss of resources but also to environmental pollution.

Another drawback to this method is the presence of a finely dispersed silicon dioxide suspension, which presupposes the existence of a filtration stage, leading to an increase in energy consumption as well as complications in the HF producing process itself, also increasing the duration of this process.

### SUMMARY

The technical result achieved by implementing the proposed claim is the extraction of fluorine in the form of HF from an HSA aqueous solution, while lowering the overall energy consumption of the process and reducing the formation of difficult-to-utilize waste sulfuric acid contaminated with fluorine ions by 10 times or more, up to complete elimination, which simplifies and shortens the duration of the process of HF production.

### BRIEF DESCRIPTION OF THE FIGURES

FIG. 1 displays a diagram of the unit used to obtain HF from an aqueous HSA solution.

### DETAILED DESCRIPTION

The core of the method for obtaining HF from HSA, according to the proposed patent, consists in neutralizing the HSA solution with an alkaline agent, yielding a solid salt from the suspension, processing the salt in a fire from a hydrogen-containing fuel and an oxygen-containing oxidant, cooling the combustion products, removing the silicon dioxide from these products, condensing the HF and water, and subsequently extracting the HF.

A possible alternative to the primary technical solution would be to preliminarily subject the resulting solid salt to thermal decomposition, forming gaseous fluorinated substances.

In this manner, a combination of the essential features achieves the demonstrated technical result. First, by removing the water at the filtration stage for the hexafluorosilicate, the amount of sulfuric acid consumed in the process lowers to the point that it is completely eliminated and reduces the difficult-to-utilize waste sulfuric acid contaminated with fluoride ions by 10 times or more. Second, the combustion stage of the solid hexafluoro silicate and, as a consequence, the recovery of solid silicon dioxide from its gaseous phase prevents the formation of the silicon dioxide suspension, which decreases the energy consumption of the technological process. Third, with the use of preliminary thermal decomposition of the hexafluorosilicate, the fluoride of the corresponding alkaline agent and silicon dioxide are separated in stages, making it possible to produce these compounds as additional commercial products. Fourth, implementing this process of obtaining HF from an aqueous solution of HSA eliminates the absorption stages for silicon tetrafluoride and filtration of the silicon dioxide suspension, simplifying the production process and reducing the time for one operation.

The proposed method of obtaining HF occurs as follows. An appropriate alkaline agent, for example, NaOH, Na₂CO₃, KOH, K₂CO₃, CaO, Ca(OH)₂, NH₄OH or NH₃, is continuously mixed into the initial solution of HSA in water. A fluorinated salt forms:

H₂SiF₆+2NaOH=Na₂SiF₆+2H₂O (7)

H₂SiF₆+Na₂CO₃=Na₂SiF₆+H₂O+H2O+CO₂ (8)

H₂SiF₆+2KOH=K₂SiF₆+2H₂O (9)

H₂SiF₆+K₂CO₃=K₂SiF₆+H₂O+CO₂ (10)

H₂SiF₆+CaO=CaSiF₆+H₂O (11)

H₂SiF₆+Ca(OH)₂=CaSiF₆+H₂O (12)

H₂SiF₆+2NH₄OH=(NH₄)₂SiF₆+2H₂O (13)

H₂SiF₆+2NH₃=(NH₄)₂SiF₆ (14)

If NaOH, KOH, NH₄OH or NH₃ is used as the alkaline agent, then the reagent ratio is 1.8-2 moles of alkaline agent to 1 mole of HSA.

In case Na₂CO₃, K₂CO₃, CaO or Ca(OH)₂ is used as the alkaline agent, then the reagent ratio is 0.9-1 moles of alkaline agent to 1 mole of HSA.

A 3-10% molar excess of HSA is used, as opposed to the stoichiometric value, so that the pH of the resulting solution falls in the 3-4 range. A solid dry salt is yielded by evaporating the suspensions obtained from the HSA neutralization in equations (7-14) or by filtration, followed by desiccation of the wet salt.

The solid salts obtained as a result of neutralizing the HSA in equations (7-14) are treated in a fire from a hydrogen-containing fuel—methane, for example and an oxygen-containing oxidant—for example, oxygen—forming HF in the equations:

Na₂SiF₆+2O₂+CH₄→2NaF+SiO₂+CO₂+4HF (15)

K₂SiF₆+2O₂+CH₄→2KF+SiO₂+CO₂+4HF (16)

CaSiF₆+2O₂+CH₄→CaF₂+SiO₂+CO₂+4HF (17)

(NH₄)₂SiF₆+1.5O₂→N₂+SiO₂+6HF+H₂O (18)

In reaction (18), the fuel (the ammonium component) is contained within the structure of the fluoride itself.

After that, the combustion products are sent to the solid phase separation unit, where a mixture of metal fluorides and silicon dioxide is separated from the mixture of HF and water.

The resulting HF and water mixture is channeled to a water separation unit, which is either a distillation column, an apparatus for dehydrating HF with sulfuric acid or oleum [U.S. Pat. No. 5,300,709A, Jan. 15, 1995], or a unit for high-temperature water recovery using carbon [Pashkevich D. S., Alekseev Yu. I., et al. Stability of Hydrogen Fluoride in a High-Temperature Zone of Water Recovery Using Carbon//Industry & Chemistry. 2015. T95, No. 5. p. 211-220], but is not limited to the listed options.

In the event of preliminary thermal decomposition, the solid salts yielded from neutralizing the HSA in equations (7-14) are heated to obtain volatile fluorinated compounds in the equations:

Na₂SiF₆(solid)→2NaF(solid)+SiF₄(gas) (19)

K₂SiF₆(solid)→2KF(solid)+SiF₄(gas) (20)

CaSiF₆(solid)→CaF₂(solid)+SiF₄(gas). (21)

(NH₄)₂SiF₆(solid)→(NH₄)₂SiF₆ (gas) (22)

The volatile fluorinated compounds formed in equations (19-22) are sent for processing in the fire of a hydrogen-containing fuel—for example, methane—and an oxygen-containing oxidant—for example, oxygen—forming HF:

(NH₄)₂SiF₆(gas)+1.5O₂→N₂+SiO₂+6HF+H₂O (23)

SiF₄+2O₂+CH₄→SiO₂+CO₂+4HF (24)

In reaction (23), the fuel (the ammonium component) is contained within the structure of the volatile fluoride itself.

The resulting HF and water mixture is channeled into a water separation unit, which is either a distillation column, an apparatus for dehydrating HF using sulfuric acid or oleum [U.S. Pat. No. 5,300,709A, Jan. 1, 1995], or a unit for high-temperature water recovery using carbon [Pashkevich D. S., Alekseev Yu. I., et al. Stability of Hydrogen Fluoride in a High-Temperature Zone of Water Recovery Using Carbon//Industry & Chemistry. 2015. T95, No. 5. p. 211-220], but is not limited to the listed options.

The proposed method makes it possible to reduce or completely eliminate the amount of difficult-to-utilize waste sulfuric acids contaminated with traces of HF from the process when extracting fluorine in the form of HF from aqueous solutions of HSA.

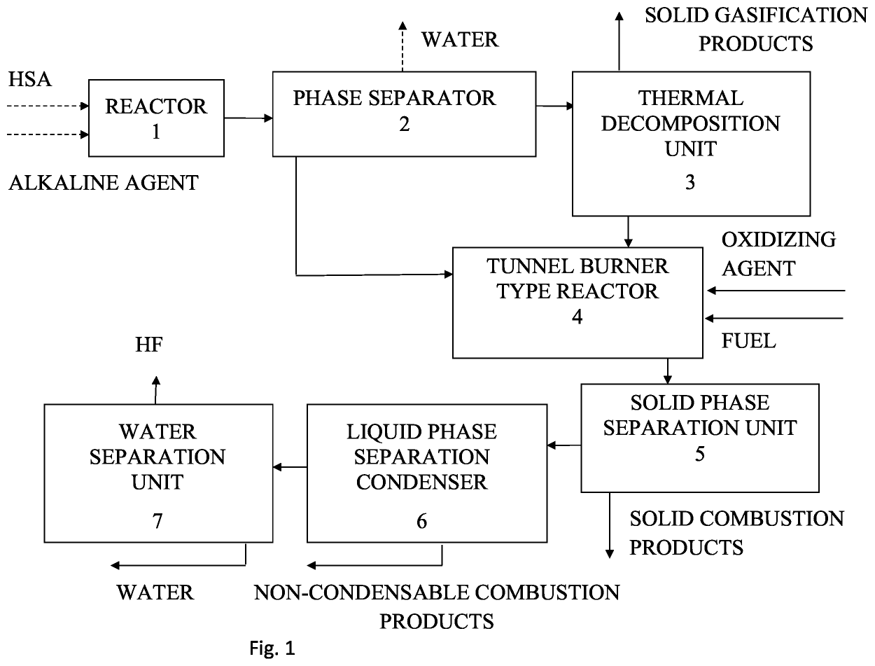

HF was obtained from an aqueous HSA solution on an apparatus, the diagram of which is shown in FIG. 1.

1—neutralization reactor

2—phase separator

3—thermal decomposition unit

4—tunnel burner type reactor

5—solid phase separation unit

6—liquid phase separation condenser

7—water separation unit

An aqueous HSA solution with a concentration of 5-45% and an alkaline agent, or its aqueous solution, is mixed continuously as it is dispensed into neutralization reactor 1, where a corresponding fluorinated salt forms. The temperature in reactor 1 is held between 0-60° C., depending on the selected alkaline agent. Then, the suspension of fluorinated salts is sent to phase separator 2, where the solid fluorinated salt and water are separated. The dry fluorinated salt is fed into a tunnel burner type reactor, where the formation of HF, silicon dioxide and, in the event the combustion process of equation (18), water occurs. An alternative option is when the dry fluorinated salt is fed into unit 3 for thermal decomposition, where the volatile fluorinated compounds form at 300-800° C. Then the dry fluorinated compounds are fed into tunnel burner type reactor 4, where treatment in the fire of hydrogen-containing fuel and an oxygen-containing oxidant takes place, forming HF, silicon dioxide, and, in the event of the combustion process in equation (24), water. Then powder products, including silicon dioxide, are separated in the unit 5, while HF and water are condensed in condenser 6. The obtained HF and water mixture is channeled to water separation unit 7, which is either a distillation column, an apparatus for dehydrating HF with sulfuric acid or oleum, or a unit for high-temperature water recovery using carbon, but is not limited to the listed options.

The examples given below demonstrate specific applications of this process.

### EXAMPLE 1

A typical waste from the production of phosphoric acid is a 20.5% aqueous solution of HSA, which is fed into reactor 1 in the amount of 3.51 kg. With vigorous mixing, 0.8 kg of an aqueous solution of 50% NaOH is channeled into the same apparatus. The temperature in reactor 1 is held at 25° C. Reactor 1 discharges 4.31 kg of a suspension of sodium hexafluorosilicate in water to phase separator 2, which is a filter that separates 0.95 kg of solid sodium hexafluorosilicate from 3.36 kg of filtrate.

A solid salt is fed at a flowrate of 75 mg/s into tunnel burner type reactor 4, which is also supplied with oxygen at a flowrate of 25.5 mg/s and methane at a flowrate of 6.5 mg/s. After combustion, the solid combustion products are separated from the gaseous products in solid phase separation unit 5, which is a cermet nickel filter. The gaseous products are channeled into condenser 6, where the HF and water are separated from the non-condensable products.

Next, the condensed mixture of HF and water is sent to water separation unit 7 to remove the water. This unit is a reactor, into which 93% sulfuric acid is fed in addition to the water-containing product, which produces HF, with a residual 0.02% water content and 75% sulfuric acid in the amount 1.2 kg per 1 kg of HF.

### EXAMPLE 2

A typical waste from the production of phosphoric acid is a 20.5% aqueous solution of HSA, which was fed into reactor 1 in the amount of 3.51 kg. With vigorous mixing, 0.68 kg of an aqueous solution of 25% ammonia is channeled into the same apparatus. The temperature in reactor 1 is maintained at 0-5° C. A suspension of ammonium hexafluorosilicate in water is discharged in the amount of 4.19 kg from reactor 1 and sent to phase separator 2, which is a filter that separates 0.89 kg of solid ammonium hexafluorosilicate from 3.3 kg of water at 100° C.

The solid salt is sent to unit 3 for thermal decomposition, where the ammonium hexafluorosilicate sublimates completely at T=300° C.

Gaseous ammonium hexafluorosilicate is collected in a heated container and fed at a flowrate of 70 mg/s into tunnel burner type reactor 4, which is also supplied with oxygen at 20 mg/s. The fuel needed for burning is contained within the ammonium salt component. After combustion, the solid combustion products are separated from the gaseous products in solid phase separation unit 5, which is a cermet nickel filter. The gaseous products are channeled into condenser 6, where the HF and water are separated from the non-condensable products.

Next, the condensed mixture of HF and water is sent to water separation unit 7 to remove the water. This unit is a reactor, into which 93% sulfuric acid is fed in addition to the water-containing product, which produces HF, with a residual 0.02% water content and 75% sulfuric acid in the amount 0.8 kg per 1 kg of HF.

### EXAMPLE 3

A typical waste from the production of phosphoric acid is a 20.5% aqueous solution of HSA, which was fed into reactor 1 in the amount of 3.51 kg. With vigorous mixing, 0.28 kg of an alkaline agent, CaO, is channeled into the same apparatus. The temperature in reactor 1 is maintained at 50-60° C. A suspension of calcium hexafluorosilicate in water is discharged in the amount of 3.79 kg from the neutralization apparatus and sent to solid salt phase separator 2, which is a filter that separates 0.94 kg of solid calcium hexafluorosilicate from 2.85 kg of filtrate. The solid salt is sent to unit 3 for thermal decomposition, where the calcium hexafluorosilicate decomposes at T=360-380° C. into gaseous SiF₄ and solid CaF₂, mixed with undecomposed calcium hexafluorosilicate.

Then the gaseous SiF₄ is channeled into tunnel burner type reactor 4 at a flowrate of 45 mg/s, where oxygen and methane are also fed at flowrates of 7 and 30 mg/s, respectively. After combustion, the solid products are separated from the gaseous products in solid phase separation unit 5, which is a cermet nickel filter. The gaseous products are channeled into condenser 6, where the HF and water are separated from the non-condensable products.

Next, the condensed mixture of HF and water is sent to water separation unit 7 to remove the water. This unit is a reactor, into which 93% sulfuric acid is fed in addition to the water-containing product, which produces HF, with a residual 0.03% water content and 75% sulfuric acid in the amount 0.6 kg per 1 kg of HF.

This patent relates to the mineral waste treatment of the phosphate chemical industry, namely, treatments of hexafluorosilicic acid solutions formed specifically during the process of producing phosphoric acid with hydrogen fluoride. The method for obtaining hydrogen fluoride from hexafluorosilicic acid, according to the proposed patent, consists of neutralizing the HSA solution with an alkaline agent, yielding a solid salt from the suspension, processing the salt in a fire of a hydrogen-containing fuel and an oxygen-containing oxidant, cooling the combustion products, eliminating the silicon dioxide from these products, condensing the hydrogen fluoride and water, and subsequently extracting the hydrogen fluoride. The technical result achieved by implementing the proposed claim is the extraction of fluorine in the form of hydrogen fluoride from an aqueous solution of hexafluorosilicic acid, while lowering the overall energy consumption of the process and reducing the formation of difficult-to-utilize waste sulfuric acid contaminated with fluorine ions by 10 times or more, up to complete elimination, which will simplify and shorten the duration of the process of hydrogen fluoride production.

1. A method of producing hydrogen fluoride from hexafluorosilicic acid (HAS), the method comprising:
neutralizing the HSA solution with an alkaline agent,
yielding a solid salt from the suspension,
processing the salt in a fire of a hydrogen-containing fuel and an oxygen-containing oxidant,
cooling the combustion products,
eliminating the silicon dioxide from these products,
condensing the hydrogen fluoride and water, and
subsequently extracting the hydrogen fluoride.

2. The method in claim 1, wherein the formed solid salt is preliminarily subjected to thermal decomposition to form gaseous fluorinated substances.
